(19) United States
(12) Patent Application Publication
(10) Pub. No.: US 2026/0056660 A1
(43) Pub. Date: Feb. 26, 2026

(54) OPTIMIZING DATA RETRIEVAL FROM STORAGE DEVICES

(71) Applicant: Sandisk Technologies, Inc., Milpitas, CA (US)

(72) Inventor: Ramanathan MUTHIAH, Bangalore (IN)

(73) Assignee: Sandisk Technologies, Inc., Milpitas, CA (US)

(21) Appl. No.: 18/813,213

(22) Filed: Aug. 23, 2024

(51) Int. Cl. G06F 3/06

(52) U.S. Cl. CPC G06F 3/0611; G06F 3/0659; G06F 3/0679

(57) ABSTRACT

A storage device may store data based on the data retrieval efficiency. The storage device includes a memory device to store the data. A controller in the storage device may receive write commands to write data to the memory device and may evaluate an optimal number of retrieval chunks or an optimal number of read sense operations for a write command. The controller may determine if, based on a current write offset in a block in the memory device and a size of the data associated with the write command, a write operation would result in efficient retrieval of the data from the memory device. If the controller determines that the write operation would result in inefficient retrieval of the data from the memory device, the controller may relocate the current write offset. The controller may select a pending write command for execution based on the current write offset.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks. Physical blocks from multiple dies may also be configured to form a super block. i.e., a logical block which may be composed of physical blocks from all the dies and channels in the memory device to extract higher throughput for parallel reads and writes. The memory device may be programmed and sensed at a block level.

When data is being programmed on the memory device, the data may be assigned logical block addresses (LBAs) that may be mapped one-to-one to physical addresses on the memory device. The one-to-one LBA to physical address mappings may be stored in a logical-to-physical (L2P) table. Storage devices using LBAs are referred to herein as LBA storage devices. When an LBA storage device writes data, the data may be written in a super block from the current write offset (i.e., the location immediately after the last data written to the super block). Once the data is written, the current write offset moves to the end of the just written data so that the next data written to the block can be written from that point. Data stored using LBAs may be sequential or random. For example, a first sixty-four kilobytes (KB) of data may be written to the memory device via a first command and its logical extension (for example, a second sixty-four KB data) may be written to the memory device via a second command. The LBA storage device could potentially retrieve the entire 128KB sequential data from the memory device with a single read command since the data is logically connected. The LBA storage device may also use the LBAs to write multiple random host streams to the super blocks, wherein the random host streams may not be logically connected.

The storage device may be a key-value storage device that may store variable-length data in blocks on the memory device, wherein the variable-length data may be stored as a single value in contiguous bytes on the memory device. The key-value storage device may address the value with a unique key associated with the value, wherein the value may be stored and retrieved from the memory device as one addressable object. For example, the key-value storage device may store a photo with an associated key or a video with an associated key as a single addressable value. The key-value storage device may also store, for example, a medical record with a unique identifier or an employment record with a unique identifier as a single value. The value associated with a key is independent of other keys and their values. As such, there is no obligation for the key-value storage device to keep different data together to reduce latency.

The most efficient way to write to the memory device is to use the smallest number of program operations to write data of a given size in each device geometry. Similarly, the most efficient way to read data from the data is to use the least number of read sense operations to retrieve data of a given size in each device geometry. It may be possible, based on the size of the data to be written and the current offset, that an LBA storage device or a key-value storage device may write data to more blocks than it would otherwise use if the data was written from a different offset. In this manner the current offset of the block may affect the efficiency of the program and read sense operations of the storage device.

Consider an example where key-value data of 20KB is to be written to a super block (for example, with 16KB blocks), and the current block where the data may be written has a non-zero write offset. 20KB is more than 16KB (i.e., the block size) and in an ideal scenario, two program operations would be used (i.e., the data would be written to two blocks). If the current write offset is such that, for example, 2KB may be written to the current block, rather than using two program operations to store the data, three program operations would be used to write the 20KB data to the blocks on the memory device from the current write offset. When the data is written to three blocks, three read sense operation would be needed to retrieve the data. As such, how the data is programmed may impact the retrieval efficiency when reading the data from the memory device, thus affecting the performance of the storage device.

### SUMMARY OF THE INVENTION

In some implementations, the storage device may store data based on the data retrieval efficiency. The storage device includes a memory device to store the data. A controller in the storage device may receive write commands to write data to the memory device and may evaluate an optimal number of retrieval chunks or an optimal number of read sense operations for a write command. The controller may determine if, based on a current write offset in a block in the memory device and a size of the data associated with the write command, a write operation would result in efficient retrieval of the data from the memory device. If the controller determines that the write operation would result in inefficient retrieval of the data from the memory device, the controller may relocate the current write offset. The controller may select a pending write command for execution based on the current write offset.

In some implementations, a method is provided on a storage device for storing data based on data retrieval efficiency. The method includes receiving commands to write data to the memory device and evaluating an optimal number of retrieval chunks or an optimal number of read sense operations for a write command. The method also includes determining if, based on a current write offset in a block on the memory device and a size of the data associated with the write command, a write operation would result in efficient retrieval of the data from the memory device. The method further includes relocating the current write offset if the write operation would result in inefficient retrieval of the data from the memory device, and selecting a pending write command for execution based on the current write offset.

In some implementations, the storage device includes a controller to receive commands to write data to the memory device. The storage device also includes an arbitration module to determine which pending write command stored in a command queue can be optimally written to the memory device, given a current write offset. The storage device further includes an arbitration module to evaluate an optimal number of read sense operations for a write command, determine if, based on a current write offset in a block in the memory device and a size of the data associated with the write command, a write operation would result in efficient retrieval of the data from the memory device, and pad the block with data to relocate the current write offset if the write operation would result in inefficient retrieval of the data from the memory device. The controller selects a pending write command for execution based on the current write offset.

### BRIEF DESCRIPTION OF THE DRAWINGS

FIG. 1 is a schematic block diagram of an example system in accordance with some implementations.

FIG. 2 is an example block diagram showing alignment in a super block configuration in a memory device in accordance with some implementations.

FIG. 3 is an example block diagram showing alignment in a super block configuration based on the sizes of data associated with pending commands and a current write offset in accordance with some implementations.

FIG. 4 is an example flow diagram of dynamic alignment of data to be written to a memory device based on a current write offset and the size of the data in accordance with some implementations.

FIG. 5 is an example flow diagram of dynamic alignment of data to be written to a memory device based on a current write offset and the data sizes associated with write commands in a command queue in accordance with some implementations.

FIG. 6 is an example flow diagram of how a controller in a LBA storage device evaluates whether or not to apply the padding based on the type of data it receives in accordance with some implementations.

FIG. 7 is an example flow diagram of how a storage device may correct alignment as a part of a background operation in accordance with some implementations.

FIG. 8 is a diagram of an example environment in which systems and/or methods described herein are implemented.

FIG. 9 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

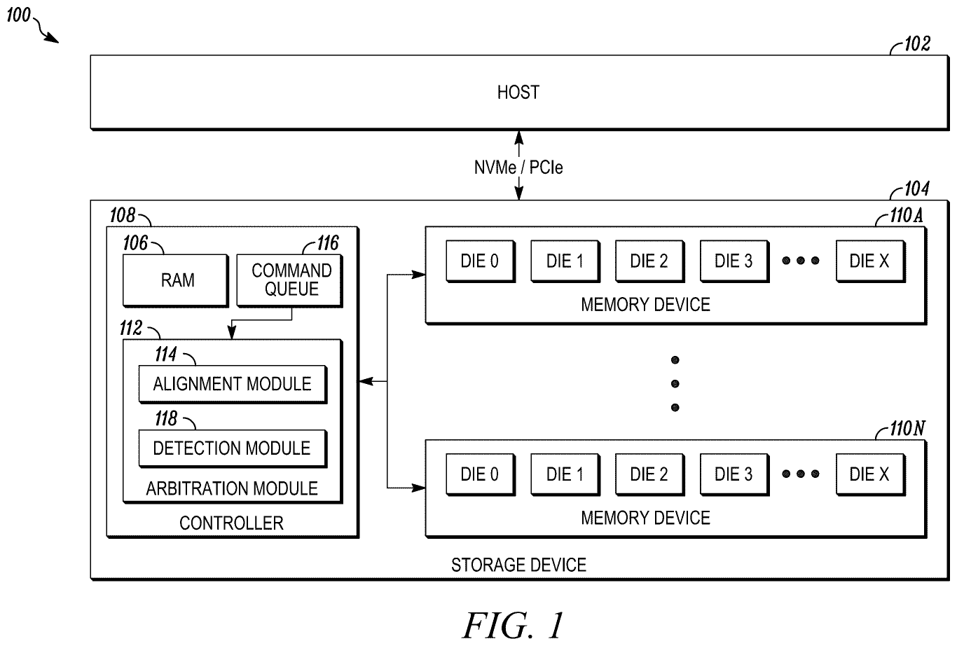

FIG. 1 is a schematic block diagram of an example system in accordance with some implementations. System 100 includes a host 102 and a storage device 104 that may be in the same physical location as components on a single computing device or on different computing devices that are communicatively coupled. Storage device 104, in various embodiments, may be disposed in one or more different locations relative to the host 102. System 100 may include additional components (not shown in this figure for the sake of simplicity).

Storage device 104 may include a random-access memory (RAM) 106, a controller 108, one or more non-volatile memory devices 110a-110n (referred to herein as the memory device(s) 110), an arbitration module 112, an alignment module 114, a command queue 116, and detection module 118. Storage device 104 may be, for example, a solid-state drive (SSD). When storage device 104 accesses data stored on memory device 110 via logical block addresses (LBAs), storage device 104 may be referred to herein as a LBA storage device and when storage device 104 accesses data stored on memory device 110 via keys associated with key-value pairs, storage device 104 may be referred to herein as a key-value (KV) storage device. RAM 106 may be static RAM (SRAM) or a dynamic RAM (DRAM) that may be used to store information such as a logical-to-physical (L2P) table used on storage device 104.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include multiple dies (for example, DIE 0- DIE X) for storing the data. The dies may be divided into physical blocks that may be grouped together into a plane. A memory die may include a single plane full of data blocks or multiple planes that have been linked together. Physical blocks from multiple dies may also be configured to form a super block. i.e., a logical block which may be composed of physical blocks from all the dies and channels in the memory device to extract higher throughput for parallel reads and writes. Memory device 110 may be included in storage device 104 or may be otherwise communicatively coupled to storage device 104.

When storage device 104 receives a write command, storage device 104 may determine if the write operation is associated with random host streams or key-value data. Prior to writing the data to memory device 110, controller 108 in, for example, an LBA storage device, may evaluate the optimal number of memory device retrieval chunks that may be required when the size of the data to be written is subsequently read from memory device 110. In, for example, a KV storage device, prior to writing the data to memory device 110 controller 108 may determine the optimal number of read sense operations when the size of the data to be written is subsequently read memory device 110. Controller 108 may then determine if, based on the current write offset in a super block and the size of the data, the write operation would result in efficient retrieval of the data.

In an implementation, if controller 108 determines, based on the current write offset in a super block and the size of the data, that the number of write chunks would be more than an number of optimal retrieval chunks, rather than starting the write operation from the current write offset in the super block, controller 108 may trigger alignment module 114 to provide the necessary padding to the current block such that the padding may move/relocate the current write offset to allow for efficient retrieval of the data. Similarly, if controller 108 determines, based on the current write offset in a super block and the size of the data, that the number of read sense operations associated with writing the data at the current write offset would be more than a number of optimal read sense operations, rather than starting the write operation from the current write offset in the super block, controller 108 may trigger alignment module 114 to provide the necessary padding to the current block such that the padding may relocate the current write offset to allow for efficient retrieval of the data.

Consider an example where there is a pending write command for 20 KB of data to be written to a first block (for example, a 16KB block) with a non-zero offset such that 2KB of data may be written to the first block. Controller 108 may trigger alignment module 114 to determine the optimal number of subsequent read sense operations given the size of the data and the geometry of the block. With the current write offset, alignment module 114 would pad 2KB of data in the first block. In some cases, alignment module 114 may pad the super block with dummy data. Post padding, the current write offset would be at the start of a second block and controller 108 may write the first 16KB of data in the second block and the remaining 4KB of data in a third block.

In another example if there is a pending write command for 18KB of data and the current write offset is a non-zero offset in the first block such that 2KB of data may be written to the first block, controller 108 may trigger alignment module 114 to determine the optimal number of subsequent read sense operations given the geometry of the super block and the size of the data. Based on feedback from alignment module 114, controller 108 may write the first 2KB of data in the super block and the remaining 16KB of data in a second block. Thus, in this example there may be no need to modify the alignment of the current write offset. As such, controller 108 may use the current write offset or modify/relocate the current write offset when the retrieval efficiency matches an optimal number of read sense operations for retrieving data of a given size, thereby increasing the read performance of storage device 104 as a tradeoff with increased write-amplification.

In another implementation, the alignment may be dynamically modified based on the current write offset and the data sizes associated with write commands in command queue 116. Storage device 104 may store pending write commands in command queue 116 and prior to executing a pending write command that is stored in command queue 116, controller 108 may trigger arbitration module 112. When triggered, arbitration module 112 may bias some store commands against other store commands based on the various sizes of the pending write data and the current write offset. Arbitration module 112 may determine which of the pending write commands stored in command queue 116 can be optimally written to memory device 110 first, given the current write offset. If arbitration module 112 determines that the number of write chunks in a first command is not optimal or that the read sense operations associated with the first comment is not optimal so that the data may not be efficiently retrieved from memory device, arbitration module 112 may check a second command, and so on, until arbitration module 112 finds a pending command that fits the criteria (i.e., a write command with a data size that, if written from the current write offset, may be efficiently retrieved from memory device).

If arbitration module 112 determines that none of the queued commands fit the criteria, alignment module 114 may pad the super block with the current write offset with, for example, dummy data. After the padding, the current write offset may cause the selection of a pending write command with a data size that, if written from the current write offset, may be efficiently retrieved from memory device. If alignment module 114 determines that, for example, the second command has a data size that, if written from the current write offset, may be efficiently retrieved from memory device, alignment module may select the second command in command queue 116 and may write or cause controller 108 to write the second command to memory device 110 starting at the current write offset.

In some cases, padding may not be avoided. Nevertheless, alignment module 114 may select commands from command queue 116 consistent with the current write offset (system state) to have minimal or no padding. Alignment module 114 may be optionally switched off based on write amplification versa retrieval efficiency system requirements. Arbitration module 112 and alignment module 114 may thus be used to reduce write amplification while ensuring efficient retrieval of data based on how the data is programmed on memory device 110, causing storage device 104 to implement efficient retrieval mechanisms, both in terms of power and performance

Consider an example where command queue 116 includes a first command with key-value data of 20KB, a second command with key-value data of 18KB, and a third command with key-value data of 6KB to be written to, for example, a 16KB block with a non-zero offset such that a first block has space for 2KB. Alignment module 114 may select the second command to be written to the first block and a second block, moving the current write offset to the beginning of a third block. arbitration module 112 may then select the first command to be written to the third block and a fourth block, moving the current write offset into the fourth block. Arbitration module 112 may then select the third command to be written to the fourth block such that the fourth block may have a non-zero offset and space for 6KB to be written to that block. As such, each of the first and second commands may require two sense operations during retrieval.

In an implementation using a LBA storage device where controller 108 is using a common meta block for multiple random streams (for example, host streams with random workload), controller 108 may consider padding the written meta pages, such that it may align a random stream to a beginning of a meta page and optimize the time for retrieving the random stream from the memory device. This may be applicable since the random data may be fragmented in the physical block. Multiple random host streams that comprise of random command sizes (such as 8KB, 16KB, 24KB) could stand to gain retrieval quality-of-service when aligned at memory device page boundary during write operations.

Controller 108 may evaluate whether or not to apply the padding based on the type of data it receives. For example, if controller 108 determines that the commands writes are sequential in nature, it may not perform padding. In determining whether or not to apply padding, controller 108 may evaluate data LBA continuation, randomness, and/or the destination meta block. If controller 108 determines that the data is random (i.e., not sequential to a previous write operation), controller 108 may determine retrieval efficiency based, for example, on the data size and the current write offset in the destination block. If controller 108 determines that alignment is needed, controller 108 may apply alignment (with or without padding) to ensure efficient retrieval.

Controller 108 in a LBA storage device 104 or a key-value storage device 104 may also correct alignment as a part of a background operation such as garbage collection, read scrub, and relocation, when it determines that the way the data is being stored during the background operation will not yield efficient retrieval of data from memory device 110. During background operations, detection module 118 may dynamically detect writes/stores that are not aligned efficiently for data retrieval. As an example, detection module 118 may track the host retrieval size (for example, the size of host read request) and the number of memory device reads for that size and the optimal read requirement to evaluate maximum retrieval efficiency. If during background relocation controller, 108/detection module 118 determines that retrieval efficiency can be further improved, controller 108 may make correct alignment (for example, modify where and how data is stored on memory device 110 based on the current write offset, data size, and/or relocation of the current write offset) during data movement when it determines any inefficiency in storage as per detection module 118 evaluation.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

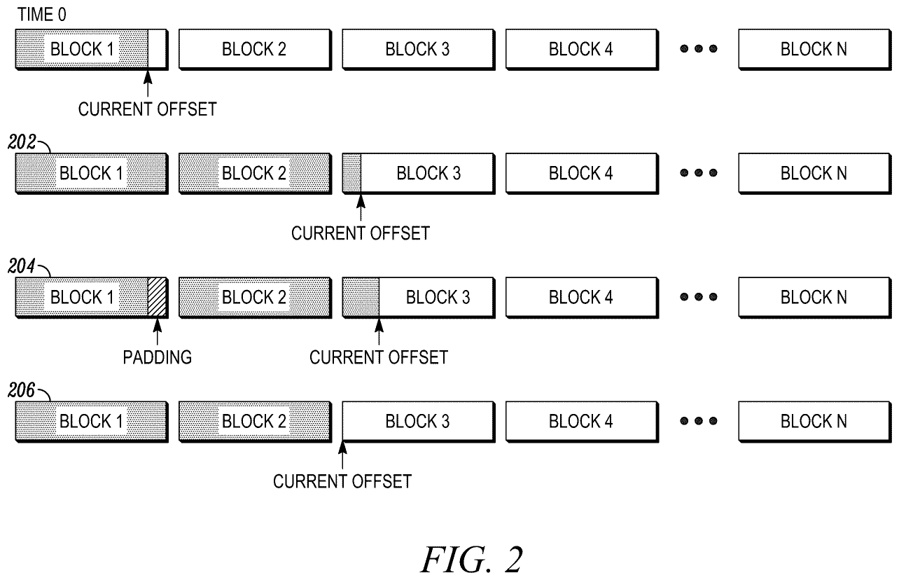

FIG. 2 is an example block diagram showing alignment in a super block configuration in a memory device in accordance with some implementations. Memory device 110 may include blocks 1-N and a current write offset may be in block 1 such that space for 2KB may be available in block 1, at Time 0. Shaded portions in blocks 1-N are provided to show stored data. 202 shows a configuration where a pending command with 20KB data may be written to blocks 1-3 without prior alignment. When the data is retrieved from memory device 110, controller 108 may execute three read sense operations to sense the data in blocks 1-3. Controller 108 may determine that the configuration in 202 does not yield the most efficient retrieval of the data from memory device. As such, controller 108 may use the configuration in 204 where a pending command with 20KB data may be written to blocks 2-3 after alignment. When the data is retrieved from memory device 110, controller 108 may execute two read sense operations to sense the data in blocks 2-3, resulting in better retrieval efficiency than the retrieval efficiency associated with the configuration of 202. If the pending command includes 18KB of data rather than the 20KB shown in configurations 202 and 204, controller 108 may use the configuration in 206 where a the 18KB data may be written to blocks 1-2 without alignment. When the data is retrieved from memory device 110, controller 108 may execute two read sense operations to sense the data in blocks 1-2. As such, controller 108 may use a default alignment based on the current write offset or may modify the alignment by modifying the current write offset to achieve an efficient retrieval result that is close to or that matches an optimal number of read sense operations. As indicated above FIG. 2 is provided as an example. Other examples may differ from what is described in FIG. 2.

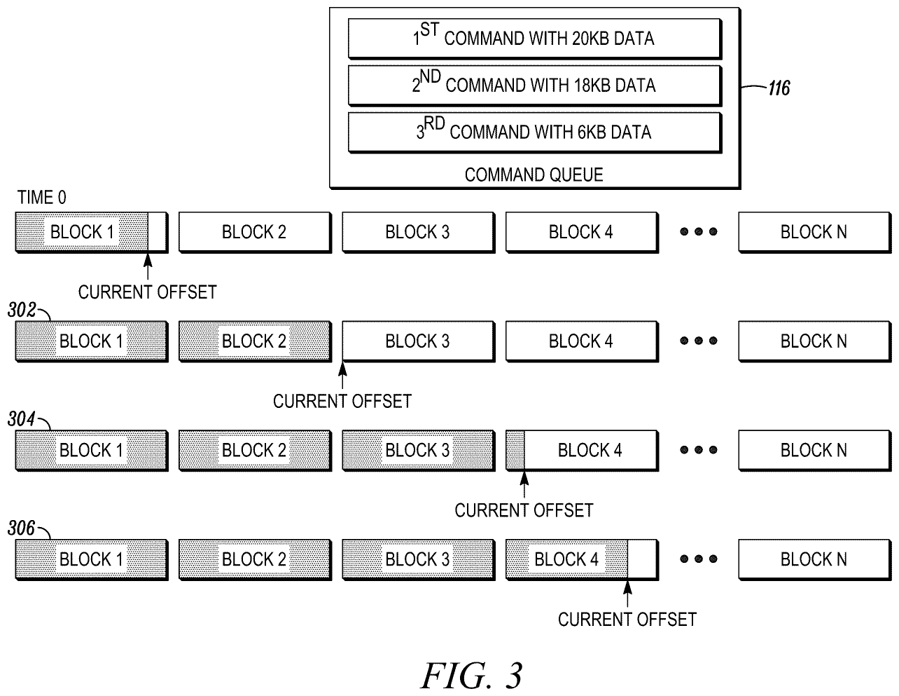

FIG. 3 is an example block diagram showing alignment in a super block configuration based on the sizes of data associated with pending commands and a current write offset in accordance with some implementations. Command queue 116 includes a first command with key-value data of 20KB, a second command with key-value data of 18KB, and a third command with key-value data of 6KB. The data associated with the commands in command queue 116 may be written to blocks 1-N. At Time 0, the current write offset may be in block 1 such that space for 2KB may be available in block 1. Shaded portions in blocks 1-N are provided to show stored data. Alignment module 114 may select the second command to be written to block 1 and block 2, moving the current write offset to the beginning of block 3, as shown in 302. Alignment module 114 may then select the first command to be written to block 3 and block 4, moving the current write offset into block 4, as shown in 304. Alignment module 114 may then select the third command to be written to block 4 such that block 4 may have a non-zero offset and space for 6KB to be written to that block, as shown in 306. During retrieval of each of the first and second commands, controller 108 may execute two sense operations, an optimal number of read sense operations given the data sizes and device geometry. As indicated above FIG. 3 is provided as an example. Other examples may differ from what is described in FIG. 3.

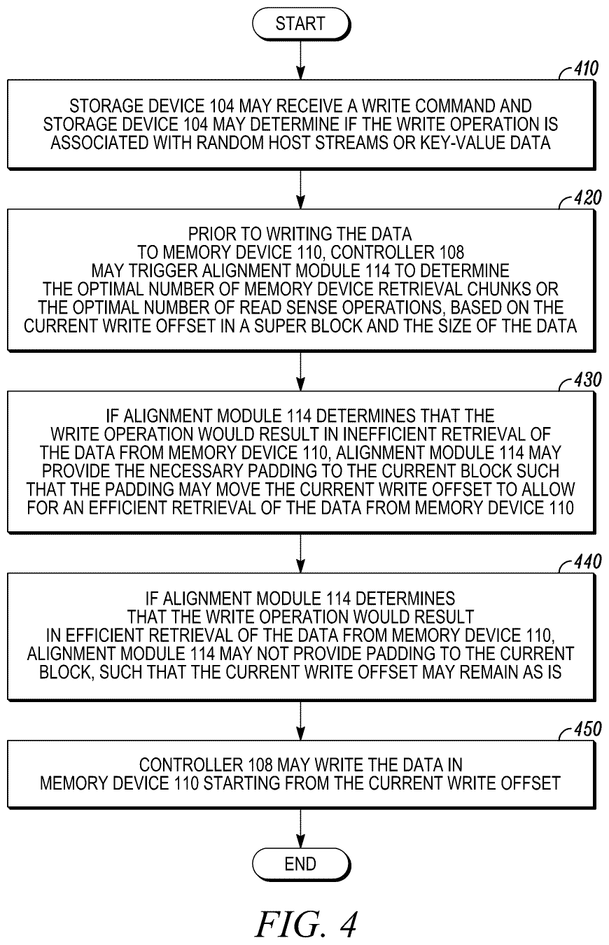

FIG. 4 is an example flow diagram of dynamic alignment of data to be written to a memory device based on a current write offset and the size of the data in accordance with some implementations. At 410, storage device 104 may receive a write command and storage device 104 may determine if the write operation is associated with random host streams or key-value data. At 420, prior to writing the data to memory device 110, controller 108 may trigger alignment module 114 to determine the optimal number of memory device retrieval chunks or the optimal number of read sense operations, based on the current write offset in a super block and the size of the data. At 430, if alignment module 114 determines that the write operation would result in inefficient retrieval of the data from memory device 110, alignment module 114 may provide the necessary padding to the current block such that the padding may move the current write offset to allow for an efficient retrieval of the data from memory device 110. At 440, if alignment module 114 determines that the write operation would result in efficient retrieval of the data from memory device 110, alignment module 114 may not provide padding to the current block, such that the current write offset may remain as is. At 450, controller 108 may write the data in memory device 110 starting from the current write offset. As indicated above FIG. 4 is provided as an example. Other examples may differ from what is described in FIG. 4.

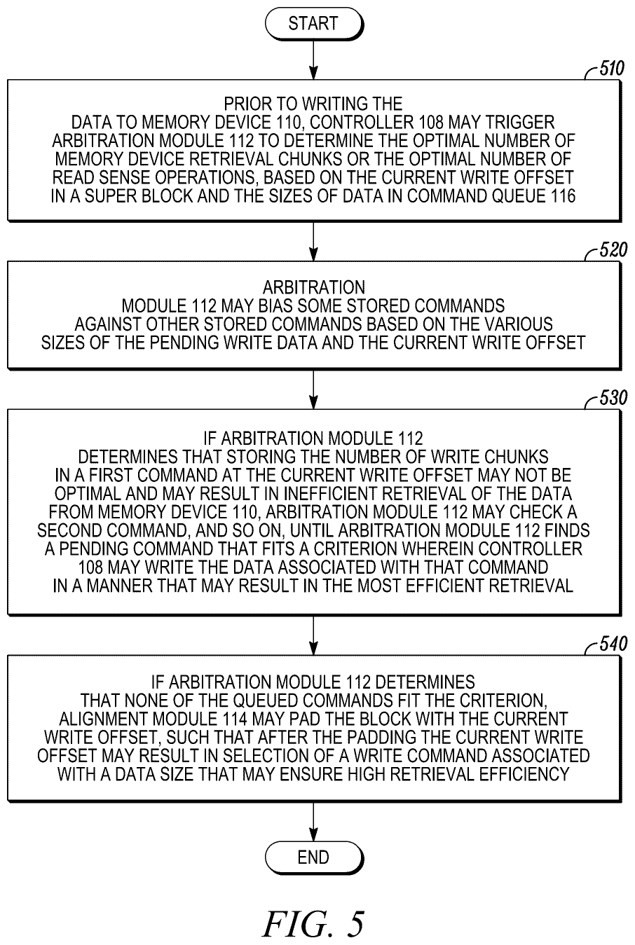

FIG. 5 is an example flow diagram of dynamic alignment of data to be written to a memory device based on a current write offset and the data sizes associated with write commands in a command queue in accordance with some implementations. At 510, prior to writing the data to memory device 110, controller 108 may trigger arbitration module 112 to determine the optimal number of memory device retrieval chunks or the optimal number of read sense operations, based on the current write offset in a super block and the sizes of data in command queue 116. At 520, arbitration module 112 may bias some store commands against other store commands based on the various sizes of the pending write data and the current write offset. At 530, if arbitration module 112 determines that storing the number of write chunks in a first command at the current write offset may not be optimal and may result in inefficient retrieval of the data from memory device 110, arbitration module 112 may check a second command, and so on, until arbitration module 112 finds a pending command that fits a criterion wherein controller 108 may write the data associated with that command in a manner that may result in the most efficient retrieval. At 540, if arbitration module 112 determines that none of the queued commands fit the criterion, alignment module 114 may pad the block with the current write offset, such that after the padding the current write offset may result in selection of a write command associated with a data size that may ensure high retrieval efficiency. As indicated above FIG. 5 is provided as an example. Other examples may differ from what is described in FIG. 5.

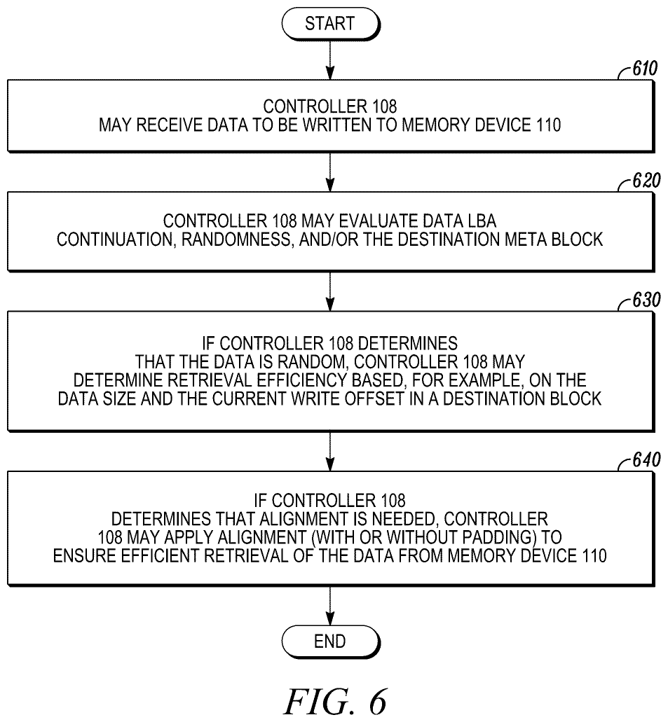

FIG. 6 is an example flow diagram of how a controller in a LBA storage device evaluates whether or not to apply the padding based on the type of data it receives in accordance with some implementations. At 610, controller 108 may receive data to be written to memory device 110. At 620, controller 108 may evaluate data LBA continuation, randomness, and/or the destination meta block. At 630, if controller 108 determines that the data is random, controller 108 may determine retrieval efficiency based, for example, on the data size and the current write offset in a destination block. At 640, if controller 108 determines that alignment is needed, controller 108 may apply alignment (with or without padding) to ensure efficient retrieval of the data from memory device 110. As indicated above FIG. 6 is provided as an example. Other examples may differ from what is described in FIG. 6.

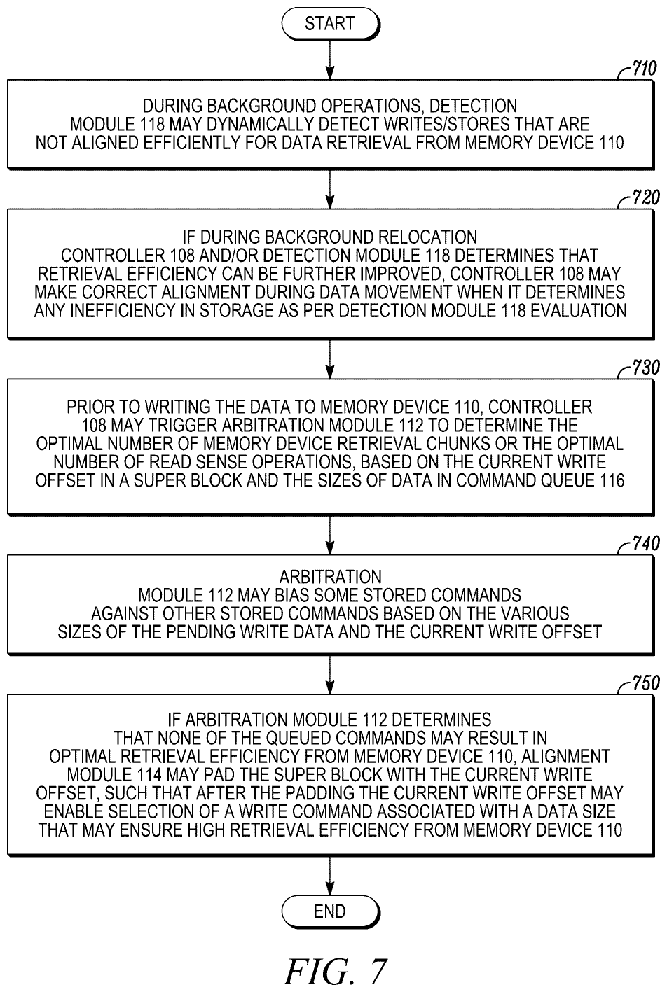

FIG. 7 is an example flow diagram of how a storage device may correct alignment as a part of a background operation in accordance with some implementations. At 710, during background operations, detection module 118 may dynamically detect writes/stores that are not aligned efficiently for data retrieval from memory device 110. At 720, if during background relocation controller 108 and/or detection module 118 determines that retrieval efficiency can be further improved, controller 108 may make correct alignment during data movement when it determines any inefficiency in storage as per detection module 118 evaluation.

At 730, prior to writing the data to memory device 110, controller 108 may trigger alignment module 114 to determine the optimal number of memory device retrieval chunks or the optimal number of read sense operations, based on the current write offset in a super block and the sizes of data in command queue 116. At 740, arbitration module 112 may bias some stored commands against other stored commands based on the various sizes of the pending write data and the current write offset. At 750, if arbitration module 112 determines that none of the queued commands may result in optimal retrieval efficiency from memory device 110, alignment module 114 may pad the super block with the current write offset, such that after the padding the current write offset may enable selection of a write command associated with a data size that may ensure high retrieval efficiency from memory device 110. As indicated above FIG. 7 is provided as an example. Other examples may differ from what is described in FIG. 7.

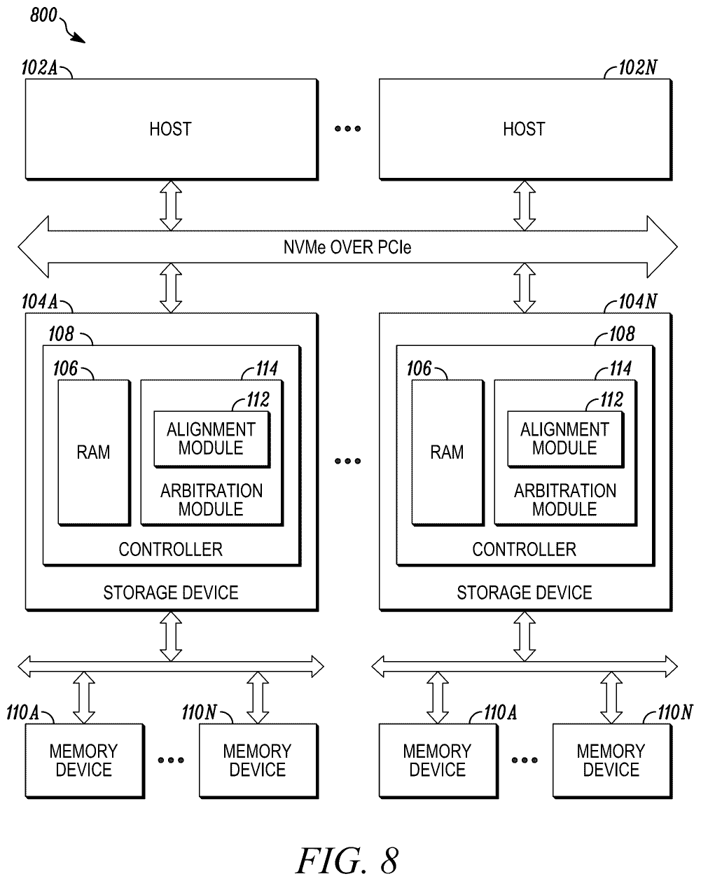

FIG. 8 is a diagram of an example environment in which systems and/or methods described herein are implemented. As shown in FIG. 8, Environment 800 may include hosts 102-102n (referred to herein as host(s) 102), and one or more storage devices 104a-104n (referred to herein as storage device(s) 104). Storage device 104 may include a controller 108 to write data to memory device 110 based on a current write offset and/or data size to ensure optimal retrieval of the data from memory device 110. Hosts 102 and storage devices 104 may communicate via Non-Volatile Memory Express (NVMe) over peripheral component interconnect express (PCI Express or PCIe), SD, or the like.

Devices of Environment 800 may interconnect via wired connections, wireless connections, or a combination of wired and wireless connections. For example, the network in FIG. 8 may include NVMe over Fabric(NVMe-oF) Internet Small Computer Systems Interface(iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of Environment 800 may perform one or more functions described as being performed by another set of devices of Environment 800.

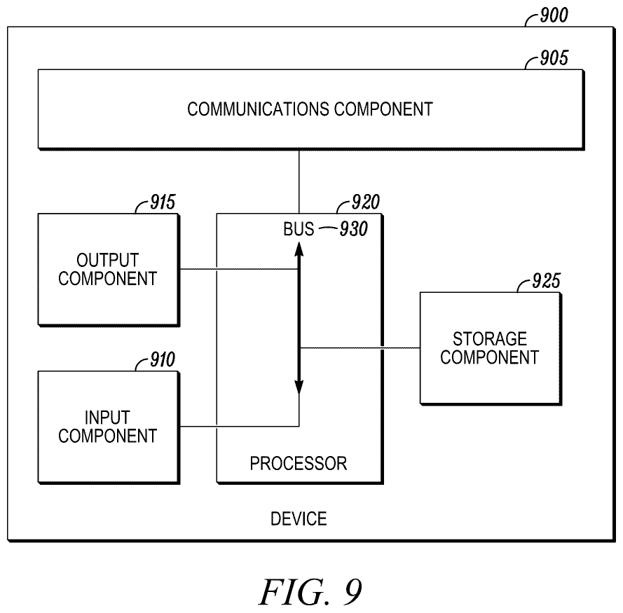

FIG. 9 is a diagram of example components of one or more devices of FIG. 1. In some implementations, host 102 may include one or more devices 900 and/or one or more components of device 900. Device 900 may include, for example, a communications component 905, an input component 910, an output component 915, a processor 920, a storage component 925, and a bus 930. Bus 930 may include components that enable communication among multiple components of device 900, wherein components of device 900 may be coupled to be in communication with other components of device 900 via bus 930.

Input component 910 may include components that permit device 900 to receive information via user input (e.g., keypad, a keyboard, a mouse, a pointing device, and a network/data connection port, or the like), and/or components that permit device 900 to determine the location or other sensor information (e.g., an accelerometer, a gyroscope, an actuator, another type of positional or environmental sensor). Output component 915 may include components that provide output information from device 900 (e.g., a speaker, display screen, and network/data connection port, or the like). Input component 910 and output component 915 may also be coupled to be in communication with processor 920.

Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 may include one or more processors capable of being programmed to perform a function. Processor 920 may be implemented in hardware, firmware, and/or a combination of hardware and software.

Storage component 925 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 920. A memory device may include memory space within a single physical storage device or memory space spread across multiple physical storage devices. Storage component 925 may also store information and/or software related to the operation and use of device 900. For example, storage component 925 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 905 may include a transceiver-like component that enables device 900 to communicate with other devices, such as via a wired connection, a wireless connection, or a combination of wired and wireless connections. The communications component 905 may permit device 900 to receive information from another device and/or provide information to another device. For example, communications component 905 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 905 may also include one or more broadband and/or narrowband transceivers and/or other similar types of wireless transceiver configurable to communicate via a wireless network for infrastructure communications. Communications component 905 may also include one or more local area network or personal area network transceivers, such as a Wi-Fi transceiver or a Bluetooth transceiver.

Device 900 may perform one or more processes described herein. For example, device 900 may perform these processes based on processor 920 executing software instructions stored by a non-transitory computer-readable medium, such as storage component 925. As used herein, the term “computer-readable medium” refers to a non-transitory memory device. Software instructions may be read into storage component 925 from another computer-readable medium or from another device via communications component 905. When executed, software instructions stored in storage component 925 may cause processor 920 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more. ” Furthermore, as used herein, the term “set” is intended to include one or more items (e.g., related items, unrelated items, a combination of related items, unrelated items, and/or the like), and may be used interchangeably with “one or more. ” The term “only one” or similar language is used where only one item is intended. Further, the phrase “based on” is intended to mean “based, at least in part, on”unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to store data based on data retrieval efficiency, the storage device comprises:
a memory device to store data; and
a controller to receive write commands to write data to the memory device, evaluate one of an optimal number of retrieval chunks and an optimal number of read sense operations for a write command, determine if, based on a current write offset in a block in the memory device and a size of the data associated with the write command, a write operation results in efficient retrieval of the data from the memory device, relocate the current write offset if the write operation results in inefficient retrieval of the data from the memory device, and select a pending write command for execution based on the current write offset.

2. The storage device of claim 1, wherein in evaluating the optimal number of retrieval chucks, the controller determines based on the current write offset and the size of the data if a number of write chunks is greater than the optimal number of retrieval chucks; and
in evaluating the optimal number of read sense operations, the controller determines based on the current write offset and the size of the data if a number of read sense operations associated with writing the data at the current offset is more than the number of optimal read sense operations.

3. The storage device of claim 1, wherein the controller pads the block with data to relocate the current write offset.

4. The storage device of claim 1, further comprising an alignment module to determine the optimal number of retrieval chucks and the optimal number of read sense operations for the write command based on the current write offset and the size of the data associated with the write command.

5. The storage device of claim 1, further comprising an arbitration module to determine which pending write command stored in a command queue to optimally write to the memory device, given the current write offset.

6. The storage device of claim 1, wherein the controller pads meta pages in the memory device to align a random stream in the pending write command to a beginning of a meta page and optimize time associated with retrieving the random stream from the memory device.

7. The storage device of claim 1, wherein the controller determines whether to add padding to a block on the memory device based on the data type.

8. The storage device of claim 1, wherein the controller determines whether to add padding to a block on the memory device based on at least one of logical block address continuation, randomness, and a destination meta block.

9. The storage device of claim 1, further comprising a detection module to dynamically detect write operations during a background operation wherein the data being stored is not aligned for efficient data retrieval from the memory device.

10. The storage device of claim 9, wherein the detection module tracks a host retrieval size and the number of memory device reads for the host retrieval size and an optimal read requirement to evaluate maximum retrieval efficiency.

11. The storage device of claim 1, wherein during background operation the controller corrects alignment during data movement upon determining an inefficiency in storage.

12. A method in a storage device for storing data based on data retrieval efficiency, the storage device comprises a controller to execute the method comprising:
receiving write commands to write data to a memory device;
evaluating one of an optimal number of retrieval chunks and an optimal number of read sense operations for a write command;
determining if, based on a current write offset in a block on the memory device and a size of the data associated with the write command, a write operation results in efficient retrieval of the data from the memory device;
relocating the current write offset if the write operation results in inefficient retrieval of the data from the memory device; and
selecting a pending write command for execution based on the current write offset.

13. The method of claim 12, wherein evaluating the optimal number of retrieval chucks, comprises determining, based on the current write offset and the size of the data, if a number of write chunks is greater than the optimal number of retrieval chucks; and
evaluating the optimal number of read sense operations, the comprises determining, based on the current write offset and the size of the data, if a number of read sense operations associated with writing the data at the current offset is more than the number of optimal read sense operations.

14. The method of claim 12, further comprising padding the block with data to relocate the current write offset.

15. The method of claim 12, further comprising determining one of the optimal number of retrieval chucks and the optimal number of read sense operations for the write command based on the current write offset and the size of the data associated with the write command.

16. The method of claim 12, further comprising determining which pending write command stored in a command queue to optimally write to the memory device, given the current write offset.

17. The method of claim 12, further comprising padding meta pages in the memory device to align a random stream in the pending write command to a beginning of a meta page and optimize time for retrieving the random stream from the memory device.

18. The method of claim 12, further comprising determining whether to add padding to a block on the memory device based on the data type.

19. The method of claim 12, further comprising detecting write operations during a background operation wherein the data being stored is not aligned for efficient data retrieval from the memory device and correcting alignment during data movement.

20. A storage device to store data based on data retrieval efficiency, the storage device comprises:
a memory device to store data;
a controller to receive write commands to write data to the memory device;
an arbitration module to determine which pending write command stored in a command queue to optimally write to the memory device, given a current write offset; and
an arbitration module to evaluate an optimal number of read sense operations for a write command, determine if, based on a current write offset in a block in the memory device and a size of the data associated with the write command, a write operation results in efficient retrieval of the data from the memory device, and pad the block with data to relocate the current write offset if the write operation results in inefficient retrieval of the data from the memory device,
wherein the controller selects a pending write command for execution based on the current write offset.
